(19) United States
(12) Patent Application Publication
(10) Pub. No.: US 2013/0035944 A1
(43) Pub. Date: Feb. 7, 2013

(54) PERSONALIZING COMMUNICATIONS BASED ON AN ESTIMATED SENSITIVITY LEVEL OF THE RECIPIENT

(71) Applicants: Joshua B. Hurwitz, Niles, IL (US); Douglas A. Kuhlman, Inverness, IL (US); Craig A. Janssen, St. Charles, IL (US); David W. Kravitz, Fairfax, VA (US)

(72) Inventors: Joshua B. Hurwitz, Niles, IL (US); Douglas A. Kuhlman, Inverness, IL (US); Craig A. Janssen, St. Charles, IL (US); David W. Kravitz, Fairfax, VA (US)

(73) Assignee: GENERAL INSTRUMENT CORPORATION, Horsham, PA (US)

(21) Appl. No.: 13/195,941

(22) Filed: Aug. 2, 2011

(51) Int. Cl. G06Q 30/00

(52) U.S. Cl. 705/1.1

(57) ABSTRACT

A “message broker” personalizes messages based on the recipient's estimated “privacy sensitivity.” By carefully estimating the sensitivity, the message broker can achieve the advantages of personalized messaging without incurring the disadvantages of offending or scaring away the recipient. In a first set of embodiments, messages are sent to a recipient, and information about the recipient's responses is collected and analyzed. The sensitivity level of the recipient is estimated based on this collected information. In a second set of embodiments, messages are sent that include an offer in which an incentive will be given to the recipient in exchange for allowing a certain type of access to specific information associated with the recipient. In a third set of embodiments, the message broker sends messages that request information associated with the recipient, but the messages do not include explicit offers to give incentives in exchange for the information.

### CROSS-REFERENCE TO RELATED APPLICATIONS

The present application is related to U.S. Patent Applications (Motorola Docket Numbers CML07590 and CS38880), filed on an even date herewith.

### FIELD OF THE INVENTION

The present invention is related generally to computer communications and, more particularly, to messaging with human beings.

### BACKGROUND OF THE INVENTION

As personal communications devices (e.g., cell phones) are developed to support greater and greater functionality, people are using them to do much more than talk. As is well known, these devices now usually allow their users to access web sites, to run web-based applications, to create media files (e.g., by taking a picture or by recording a video using a camera on the device), and to download media files from remote servers (via a web interface supported by the device). In the course of pursuing these activities, a user generates an enormous amount of information about his preferences and behaviors. Some of this information is explicitly generated when the user sets preferences in a profile. Other information may be implicit, such as the frequency with which the user runs a particular application.

Advertisers and other commercial entities are beginning to realize how valuable this information, both explicit and implicit, can be. As advertisers look beyond “traditional” media (e.g., magazines and television) to “new media” (e.g., online and mobile services) in order to increase the effectiveness of their advertising campaigns, the advertisers would like to personalize messages directed to a particular user. If the personalization is based on real information about the user's likes and dislikes, then, in theory at least, the personalized message can be more meaningful to the user than the traditional generic messages broadcast to everyone. For example, a retailer could direct messages to a user who is actively searching for information about products similar to ones that the retailer sells. This allows the retailer to tap into the needs of people prepared to buy rather than, as in the traditional approach, blindly sending advertisements to people who are simply watching television or reading a print medium.

However, users are already becoming wary of sharing their behavioral and preference information, especially with commercial entities. Some people are afraid of scams that leverage sensitive user information and of being overwhelmed with targeted advertising. There is evidence that even well-intentioned personalized messages, if they are “too” personalized, may make a user feel that his privacy has been violated. Some users may be so sensitive about their privacy that they shun new technologies and services. These users intentionally limit the spread of their personal information and thus reduce the effectiveness of those services and campaigns that depend upon such information. In certain cases, an advertiser may, in the user's opinion, “step over the line” with a highly targeted advertisement which leads the user to reject that advertisement and possibly even the context (e.g., the television show or retail environment) in which it was delivered. This specific advertisement has harmed, rather than helped, the sponsor of the advertisement.

### BRIEF SUMMARY

The above considerations, and others, are addressed by the present invention, which can be understood by referring to the specification, drawings, and claims. For each potential message recipient, that recipient's “privacy sensitivity” is estimated. A “message broker” personalizes messages (which can be of any type and delivered by any means) based on the recipient's estimated sensitivity. By carefully estimating the sensitivity, the message broker can achieve the advantages of personalized messaging without incurring the disadvantages of offending or scaring away the recipient. (Note that a recipient can be a human being but need not be: A group of people, such as a social group, could be one recipient.)

In a first set of embodiments of the present invention, messages are sent to a recipient, and information about the recipient's responses to the messages (actually, information about any recipient activities made after receipt of the messages) is collected and analyzed. The sensitivity level of the recipient is estimated based on this collected information. If, for example, the recipient's response is positive, then the estimated sensitivity level may be lowered a bit, leading to more personalized messages (e.g., messages that include more information specific to the situation of the recipient) or messages with more sensitive information in the future. If, on the other hand, the response is negative, then the estimated sensitivity level is increased, and the level of personalization or information sensitivity is lowered, at least for a while. After repeating the cycle of sending messages and analyzing responses, the estimate of the sensitivity level can become quite accurate. As the cycle continues, the estimated sensitivity level follows the recipient's actual sensitivity level up and down.

In a second set of embodiments, the message broker uses the estimated sensitivity to control the collection of valuable information associated with the recipient. Messages are sent that include an offer in which an incentive will be given to the recipient in exchange for allowing a certain type of access to specific information associated with the recipient. If the recipient accepts the offer, then the incentive is given, and the recipient information is accessed. As in the first embodiment, the sensitivity estimation is continually updated message-by-message based on the recipient's responses to the offers. If, for example, the recipient's sensitivity is estimated to be very low, then the value of the incentive may be decreased in the future, or the value of the requested information increased, or the requested level of access can be changed. (For example, aggregating the recipient's information along with information of other individuals in a large, randomized statistical sample is a lower level of access when compared to using the same information to specifically target advertising to the recipient.)

In a third set of embodiments, the message broker sends messages that request information associated with the recipient, but the messages do not include explicit offers to give incentives in exchange for the information. It is believed that once the message broker gains the trust of a recipient, that recipient will become more and more comfortable with allowing the broker to access the recipient's information. As before, the sensitivity level is constantly re-estimated based on the recipient's behavior.

Any of these embodiments can begin with an initial estimate of the recipient's sensitivity level based on information about the recipient such as demographic information, social-networking information, web-site usage patterns, purchase patterns and preferences, and the like.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of the message broker of FIG. 1;

FIGS. 3a and 3b together form a flowchart of a first embodiment of the present invention;

FIGS. 4a and 4b together form a flowchart of a second embodiment of the present invention; and

FIGS. 5a and 5b together form a flowchart of a third embodiment of the present invention.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

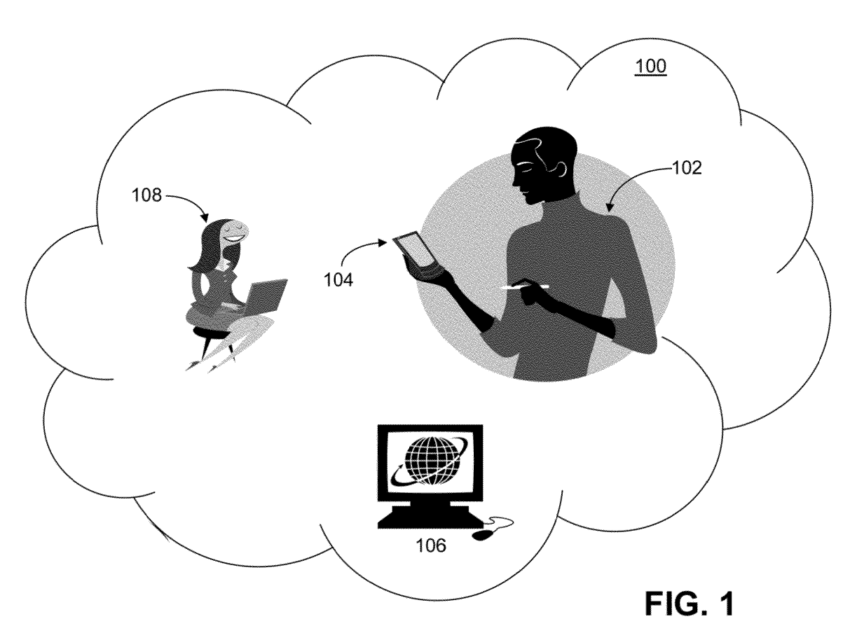

Aspects of the present invention may be practiced in the representative communications environment 100 of FIG. 1. A user 102 uses his communications device 104 to perform various tasks such as communicating with a friend 108, accessing web sites, running web-based applications for work or pleasure, shopping, and recording health information. (For reasons that are apparent later, the user 102 is also called the “recipient” throughout this discussion.) While pursuing these activities, the user 102 generates information about his behaviors, preferences, health status, and social contacts. Some of this information is explicitly generated when the user 102 sets preferences in a profile. Other information may be implicit, such as the frequency with which the user 102 runs a particular application.

This information can be of interest to numerous commercial and private entities. For example, an advertiser may like to use this information in order to tailor an advertising campaign to the specific needs and preferences of the user 102. A restaurant owner may wish to recommend restaurants that lie near a route that the user 102 often drives. A research company may wish to understand trends associated with large groups of people by analyzing very private information (e.g., prescriptions used). Politicians and pollsters could use this information to drive campaign strategies. Information is valuable.

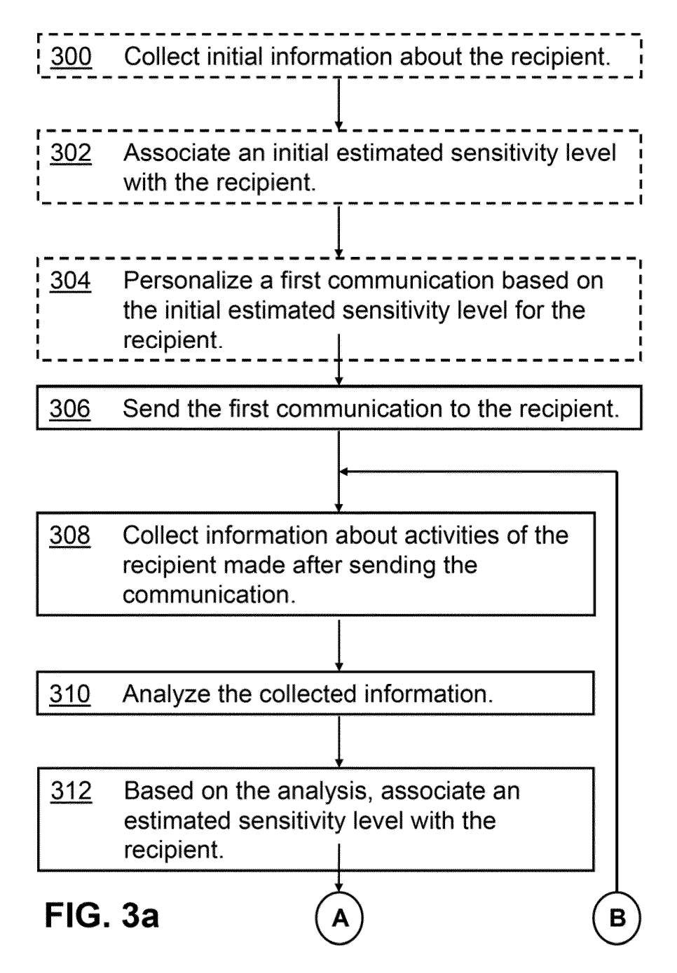

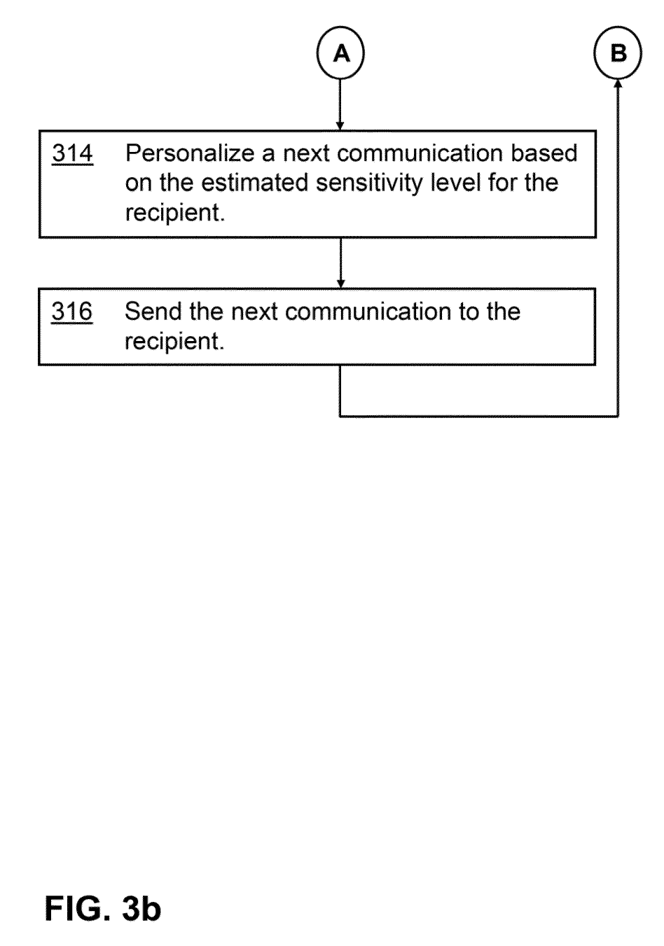

The “message broker” function 106 mediates between the user 102 with his valuable information and the commercial (or other) entities that may be interested in accessing that information. In general, the message broker 106 negotiates with the user 102 to gain access to the information associated with the user 102. (Particular aspects of this function 106 are discussed below in conjunction with FIGS. 3 through 5.) For the sake of simplicity, FIG. 1 shows the message broker function 106 as fully embodied on an Internet-based server, but in other embodiments the functions of the message broker 106 can reside within the head-end of a cable-television provider, on a set-top box in the user's home, on the user's communications device 104, or on some combination of these and other devices.

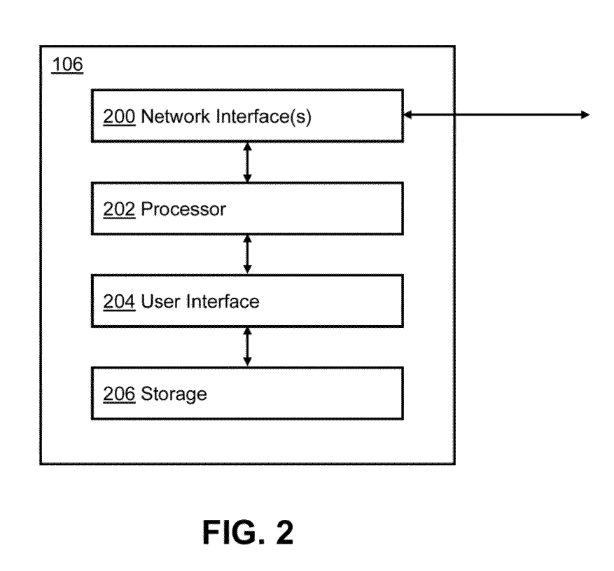

FIG. 2 shows the major components of a representative server supporting the message broker function 106. Network interfaces 200 send information requests to, and receive responses from, the user 102. These network interfaces 200 also allow the message broker 106 to communicate with the entities interested in the user's information. A processor 202 controls the operations of the message broker function 106 and, in particular, supports aspects of the present invention as illustrated in FIGS. 3 through 5, discussed below. The user interface 204 supports a user's (or administrator's) interactions with the message broker function 106. Storage 206 provides for the collection, maintenance, access, and modification of data. These data can include information collected about the user 102, specific information useful in operating the message broker 106, and information for many other purposes. Specific uses of these components by specific devices are discussed as appropriate below.

FIG. 3 presents a first exemplary embodiment of the message broker function 106 of FIG. 1. The method of FIG. 3 begins with the optional steps 300 through 304 (as indicated by dashed boxes). The present discussion first addresses only the “basic” elements (solid-line boxes). After that, these optional steps are discussed.

In step 306 of FIG. 3a, a communication is sent to the recipient (e.g., the user 102 of FIG. 1). The communication can be of any type including, for example, an advertisement sent in an e-mail or text message, a display in a computer game, a menu option, a purchase or service recommendation within an application run by the recipient 102, or a telephone call from an automated call center (although these are generally so annoying to recipients 102 that their usefulness is considered to be low). The message could be very generic, such as an advertisement on a broadcast television show, a display on a web page, or even a billboard by the side of the road (although this later possibility presents a real challenge for step 308).

The intended recipient 102 of the communication of step 306 is often a human being such but need not be. The communication could be directed to a group of people thought to share some important values, such as a self-selected social group with common interests or a group defined by shared demographic characteristics.

The sender of the communication of step 306 may simply be identified as the message broker function 106, but it is more likely that each communication will be identified with a particular sponsor or “agent.” That is, one communication can be a grocery purchase recommendation identified as sent by a local grocery store, another can be a survey associated with a commercial entity interested in gathering marketing information, yet another can be sent by a non-governmental agency trying to determine the effectiveness of a social program, for example. While each such entity could implement its own message broker function 106, a unified broker 106 working for several different agents can develop its own particular strengths, as discussed below.

After sending the communication in step 306, the message broker function 106 collects (step 308) and analyzes (step 310) information after the response of the recipient 102 to the communication. This information is used, in step 312, to estimate the privacy sensitivity of the recipient 102.

As a first example of collected information, the recipient 102 may explicitly respond by replying to the communication in either a positive or negative manner. Some communications, such as a survey message, invite such an explicit response with an interactive menu. Questions can be asked soliciting feedback from the recipient 102 about the product or service associated with the communication. The recipient 102 can also be asked to respond directly about his privacy concerns (e.g., “Is this advertisement uncomfortably direct?”). In many cases, the recipient 102 can send a reply to the communication or simply ignore it (a “null” response).

The recipient's response can also include implicit actions such as (1) viewing the entire communication rather than viewing only a part of it, or (2) viewing a web page for a product advertised in the communication, or (3) cancelling a service associated with the communication, or (4) placing a complaint with the agent associated with the communication. The recipient 102 may post a positive or negative message on a blog that can be interpreted as an indirect response to the communication. Other recipient behaviors may be known, by statistical analysis of a demographic group, to correlate with a greater or lesser privacy sensitivity. Users that frequently share personal information on social-networking sites may, for example, have a low privacy sensitivity. The sum of the recipient's responses may be partly positive and partly negative. In general, any change in the recipient's behavior associated with a product, service, or content that is associated with either the communication itself or the agent associated with the communication can be considered to be a response to the communication.

The monitoring can be accomplished in a variety of ways. The recipient's viewing can be monitored. All calls to support centers can be monitored. In some instances, the recipient 102 might post on a social networking site or use a distribution service such as Twitter to express an opinion. These are potential additional means for monitoring the recipient 102, depending on the exact context of the response. Some or all of these may be used, as available and appropriate.

In many instances, it is impossible to determine whether the activities of the recipient 102 monitored in steps 308 and 310 are actually made “in response to” the communication of step 306. For example, the communications device 104 of the recipient 102 may categorize a particular communication as spam and automatically discard it. In this case, certain activities of the recipient 102 made shortly after the receipt of the communication may seem to be relevant to the communication (e.g., the recipient 102 buys a product advertised in the communication), but are in fact not made “in response to” the communication. This lack of perfect information on the part of the message broker function 106 is not considered to be a real problem, because the message broker 106 becomes stronger as it gathers more and more information, and small deviations due to mischaracterizing any one action of the recipient 102 as triggered by the communication should be drowned out by the trends of more reliable information. In general, the more information that the message broker function 106 can analyze in step 310, the better will be the results it produces in step 314 of FIG. 3b.

In step 312 of FIG. 3a, the message broker function 106 associates an “estimated sensitivity” with the recipient 102 of the communication of step 306. In general, if the analysis of step 310 indicates that the recipient was receptive to the communication (e.g., he purchased a product advertised in the communication), then the estimate of his sensitivity is reduced. If, on the other hand, the recipient's activity indicated his displeasure with the communication (e.g., he cancelled a service or placed a complaint with the provider of a product), then the message broker 106 may increase the estimated sensitivity of the recipient 102.

It may seem that the previous paragraph assumes that the recipient's response to the communication is based entirely on his sensitivity, i.e., on whether or not the communication is perceived by him to be so directly focused on his particular preferences or behaviors that it invades his privacy. Of course, that is too simplistic. There are many reasons for responding negatively (or positively) to a particular communication. For instance, the communication can advertise a product that the recipient 102 dislikes for reasons that go beyond the content and context of the communication.

To account for this, the estimated sensitivity of step 312 in a preferred embodiment is created by a sophisticated data-analytics program that analyzes various dimensions of a particular recipient's behaviors and preferences. The resulting sensitivity can be a multi-dimensional structure with various fields, some of which apply only in various contexts. The recipient 102 may exhibit one level of privacy sensitivity in one context, and another level in another context. A recipient's preferences for, say, media downloads can depend upon whether the recipient 102 is currently driving to work or at home watching television or even upon the people around the recipient 102 at the time of the communication. Such issues about context specificity are already being addressed in the realm of social-networking research, and those results can be applied to make steps 308 through 312 as sophisticated as necessary.

In any case, the estimated sensitivity of step 312 is used in step 314 of FIG. 3b to personalize a next communication for the recipient 102. If the recipient 102 responded positively to the communication of step 306, then his sensitivity is estimated to be fairly low. Step 314 takes advantage of that fact by making the next communication more personal than it would otherwise have been. For example, the next communication can be more strongly focused on the particular preferences exhibited by this recipient 102 and can even include information specific to this recipient 102. If the recipient is known to have diabetes, for example, then the communication of step 306 may generally advertise the services of a local health-care provider, while the communication of step 314 may include a coupon for a discount on a blood-sugar monitor sold at a store near the recipient's home. If, on the other hand, the sensitivity of step 312 is estimated to be fairly high, then the next communication of step 314 is made less personal so as not to offend the recipient 102. For example, a generic advertisement can be sent. In general, the message broker function 106 uses the estimated sensitivity to known how deeply to target communications to a particular recipient 102.

The danger is that if the personalization of step 314 comes “too close to home,” then the recipient 102 will feel that his privacy has been violated (how did they know that I have diabetes?) and may respond negatively. Studies show that some privacy-sensitive people will even resist using a new service if they believe that using the service could invade their privacy. The sensitivity estimate is an attempt to personalize communications for the recipient 102 to the greatest extent compatible with the recipient's acceptance of that personalization. Personalization less than this amount reduces the effectiveness of the communications which could become too generic and “spam-like.” Personalization more than this amount offends the recipient 102 and potentially scares him away from the products or services associated with the communication. An ideal level of personalization increases both the recipient's satisfaction with the communications and the usefulness of the system to the senders of the communications.

There are many possible ways to increase (or decrease, as appropriate) the personalization of the communications. In addition to including (or excluding) information specific to the recipient 102, a frequency of communications can be altered. Thus, the message broker function 106 may only occasionally send communications to a very sensitive recipient 102, while a less sensitive recipient 102 may receive them more frequently. The order of communications may be altered to suit the recipient's sensitivity, or the agent associated with the communications can be set to an entity believed to be more trusted by the recipient 102. For a recipient 102 whose sensitivity depends upon his context, communications can be sent only when their context would make them more likely to be acceptable to the recipient 102.

Note that the communications can be of any type, and that the personalized communication sent in step 314 may be of a very different type from that sent in step 306 of FIG. 3a. Generally, the sensitivity level can be estimated from one type of communication, and used to personalize a very different type of communication. For example, after estimating the sensitivity of the recipient 102, an agent can recommend music or customized plots that may fit in with the recipient's behaviors and preferences. A video game (a type of communication) can be personalized for difficulty or content based on the information gathered and analyzed in steps 308 and 310.

As another example of personalization, the recipient 102 can be allowed to choose which advertisements he watches or could be allowed to schedule when advertisements are watched. The set of advertisements from which to choose can be created based on the recipient's estimated sensitivity. Sensitivity-based advertisements should be more acceptable to the recipient 102 and thus more effective from the agent's point of view.

The next communication, created in step 314 to be either more or less personal as deemed appropriate, is sent to the recipient in step 316.

The cycle then continues at step 308 of FIG. 3a where the message broker function 106 collects and analyzes the response of the recipient 102 to the communication sent in step 316. The message broker 106 sends communications, analyzes the response of the recipient 102, and continually refines the estimate of the recipient's sensitivity (possibly in a multi-dimensional way depending upon the context, as mentioned above).

The power of the method of FIG. 3 grows with this repetition. Each exchange may produce only a small amount of data, but over a long term, the sensitivity estimate can become quite accurate for a given recipient 102. If the sensitivity of the recipient 102 changes over time (due to external factors or possibly due to the actions of the message broker function 106 itself), then the method of FIG. 3 can follow that sensitivity up and down (given enough information to analyze in step 310), always personalizing the communications appropriately.

The message broker function 106 grows in power with the repetitions for one recipient 102, but its power grows even faster as it collects data from multiple recipients 102 in multiple situations. A vast amount of collected data may point out social trends that may be difficult to detect from the responses of a single recipient 102. Thus, there could be a great advantage to having one message broker 106 represent multiple agents in dealing with multiple recipients 102.

Returning to FIG. 3a, consider the optional steps 300 through 304. These steps occur before the first communication is sent to a new recipient 102 in step 306. The purpose of these optional steps 300, 302, 304 is to personalize that first communication at an appropriate level. To do this, information can be gathered about the new recipient 102 in step 300 and analyzed, just as in steps 308 and 310. However, this information is, by definition, NOT made in response to a communication from the message broker function 106. Instead, demographic information about the new recipient 102 may be available; purchase information or other behaviors and preferences may be known. Social-networking data may provide insights into the level of privacy desired by the new recipient 102. The results of the method of FIG. 3, as applied to recipients thought to share some characteristics with a new recipient 102, can be applied as well. Using as much information as possible, an initial estimated sensitivity is associated with the new recipient 102 in step 304, and the first communication is personalized accordingly in step 304.

If no preliminary information is available for steps 300 through 304, then the first communication of step 306 can be made very generic so as not to offend a very sensitive new recipient 102. Then, the method of FIG. 3 can work to gradually make the communications more personalized as allowed by the sensitivity of the particular recipient 102.

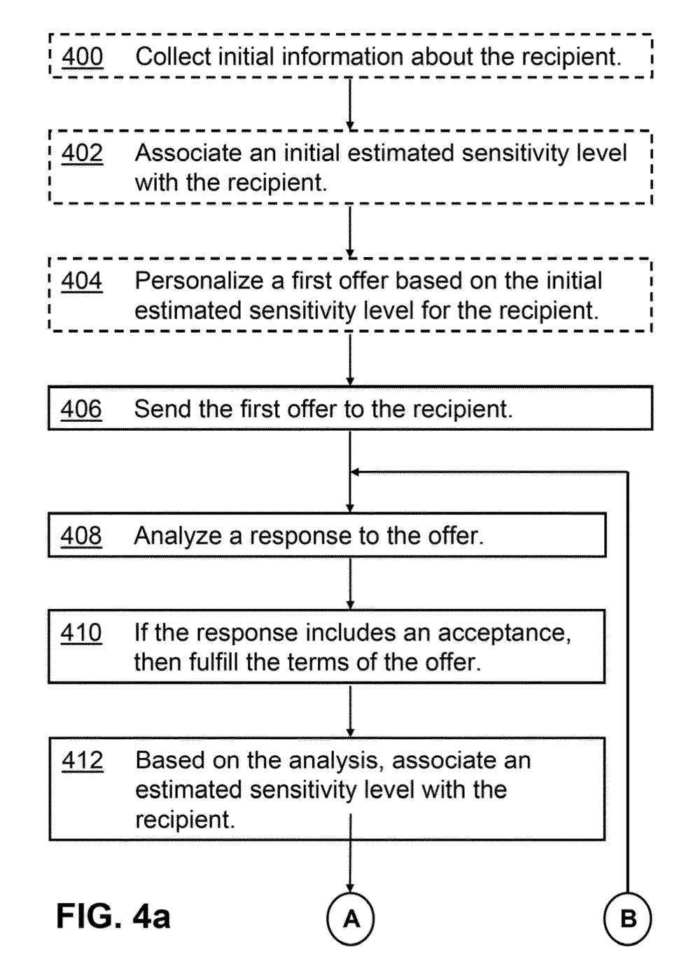

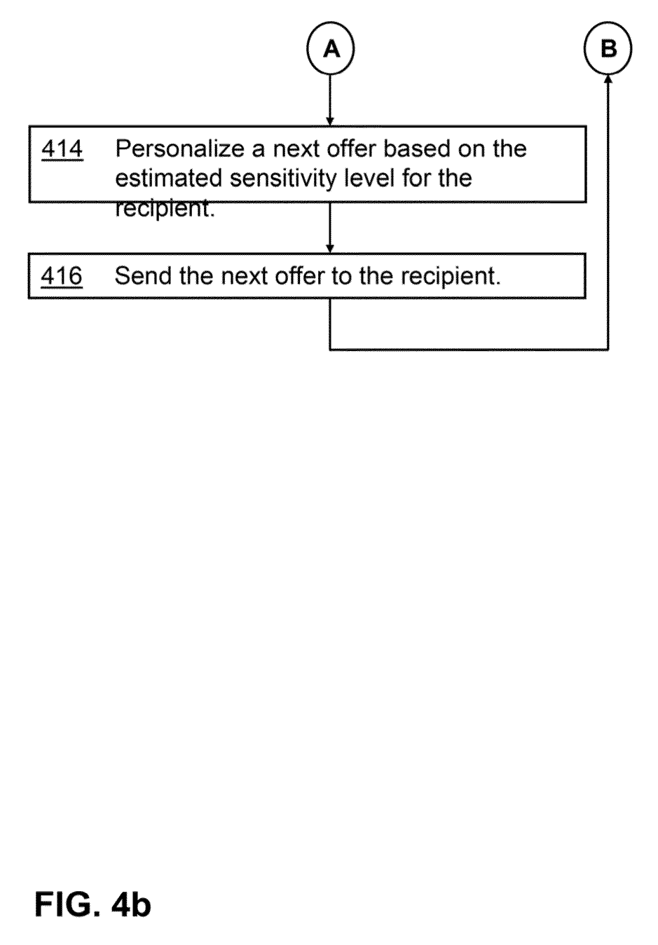

FIG. 4 presents a second exemplary embodiment of the message broker function 106 of FIG. 1. Many of the details of this embodiment are identical to, or closely parallel to, the details of the embodiment of FIG. 3, discussed above, and are not discussed again. Note that both embodiments can run simultaneously with the same recipient 102, with some communications corresponding to the embodiment of FIG. 3 and others to the embodiment of FIG. 4.

The method of FIG. 4 begins with the optional steps 400 through 402. As with the optional steps 300 through 304 of FIG. 3, these steps personalize a first communication using whatever information is already known, or can be inferred, about the intended recipient 102. Much can be done here. For example, a free service can be given to the recipient 102 tailored to his sensitivity estimated using the methods of FIG. 3. The recipient 102 can become used to interacting with the message broker function 106 before the message broker 106 begins to explicitly solicit information from the recipient 102 (step 406).

The embodiment of FIG. 4 diverges from the previously discussed embodiment in step 406. Here, the first communication is called the first “offer.” The communication presents an explicit offer of exchange to the recipient 102: If the recipient 102 allows a specific type of access to specific information associated with the recipient 102, then the message broker function 106 gives a specified incentive to the recipient 102. The thinking behind the embodiment of FIG. 4 is that the recipient 102 can be induced, by way of the incentive, to grant access to information that he would otherwise consider too private to share.

Note the use of the phrase “information associated with the recipient.” This is meant to be more general than “information controlled by the recipient.” With data-privacy becoming more highly protected by the law, it is anticipated that the message broker function 106 will need the recipient's permission to access certain types of data, even when the message broker 106 does not need to get the information directly from the recipient 102 himself. For example, the message broker 106 may be able to receive, from various retailers, information about the shopping habits of the recipient 102 but may not be allowed to use such information in a targeted advertising campaign without the recipient's permission.

The offer can request any type of access to any type of information. For example, product preferences are useful to retailers, while future travel plans might be used by a planning agent to coordinate a vacation package.

Incentives can also vary widely and will depend, in part, on the type of information access requested as well as on the estimated sensitivity level of the recipient 102. A discount can be offered for a product or service if the recipient 102 fills out a marketing survey. A recipient 102 who often responds positively to information requests can become a “preferred customer” and can be given special improvements to a service, or extra functionality in a game, or “insider” information about upcoming products or events. Removing a certain disincentive can be, of course, one type of incentive.

The recipient's response to the offer is analyzed in step 408. In particular, if the recipient 102 accepts the offer, then the terms of the offer are fulfilled in step 410. Some offers allow a more nuanced response than merely an acceptance or rejection: The recipient 102 may grant only a reduced level of access to his information in exchange for a reduced incentive. The recipient 102 may even make a counter-offer which is considered both in estimating the recipient's sensitivity (step 412) and in crafting the next offer (step 414 of FIG. 4b). In any case, the analysis of the response leads to an estimate of the recipient's privacy sensitivity in step 412, similar to the analysis and estimate of steps 310 and 312 of the previously discussed method. This analysis can include a judgment of the recipient's veracity and thus, of the value of the information accessed. Other information gathered about the recipient 102, in addition to the nature of the responses, can be used in estimating the sensitivity level.

The sensitivity estimate comes into play because requests vary widely in their level of sensitivity. The use of the recipient's health history in a statistical survey does not reveal anything specific about the recipient 102 to the general population, and is thus a “low sensitivity” request. Of much higher sensitivity is a request to publish the recipient's particular birth-control preferences for use in an advertising campaign.

Based on the estimated sensitivity level (and possibly on the estimated sensitivities of other recipients situated like this recipient 102), another offer is personalized in step 414 and sent in step 416. The process continues sending offers, analyzing responses, and using the responses to refine the estimate of the recipient's privacy sensitivity. Generally, if the recipient's responses are positive, then requests can be made for more sensitive data for reduced incentives. The opposite situation can also hold.

Setting the proper incentive level for a particular offer is important to the offeror. A higher incentive may be necessary (1) to gain access to potentially valuable information, (2) to gain access to particularly sensitive information, or (3) to gain access to information associated with a recipient 102 who has a high privacy sensitivity. The sensitivity level estimated in step 412 helps the message broker function 106 in carefully aligning the incentive with the requested access so that the offered exchange is accepted by the recipient 102 at a low enough incentive cost to be worthwhile to the agent of the message broker 106.

The level of incentive in the personalized offer of step 414 can change over time for many reasons. The recipient's data may become less valuable to the agent as his behavior becomes more predictable (although even repeated observations have some value in showing the strength of a trend in the recipient's behavior). The incentive level can change to match information gathered from other recipients 102. At some point, a particular recipient 102 may no longer be of interest to a particular agent (e.g., an agent representing a diaper service may not be interested in recipients 102 older than a certain age), and that agent, at least, would stop sponsoring offers for the recipient 102.

Several advantages accrue to the agents of the message broker function 106 by repeating the offer/exchange cycle of FIG. 4. First, as with the embodiment of FIG. 3, the exchanges allow a better understanding of the sensitivity level of the recipient 102. Second, increased knowledge allows the value of the incentives offered to a particular recipient 102 to be set at an optimal level, neither so costly that the agent does not receive enough value from the information access to be worth the exchange, nor so cheap that the recipient 102 refuses the exchange entirely.

Third, the recipient 102 can become “desensitized” to the offer/exchange process. Because the exchanges are voluntary, the recipient 102 always has control over his data. With time, the recipient 102 becomes familiar with a particular agent of the message broker function 106. If the agent shows a level of professionalism, then the recipient 102 begins to trust the agent to safeguard the recipient's information, as appropriate, and the recipient 102 becomes more comfortable in granting access to certain information, usually in exchange for a lower incentive.

This allows the sensitivity of the recipient 102 to be altered by using a careful trajectory of offers. As the recipient 102 begins to trust an agent, the agent can request higher levels of access to the recipient's data.

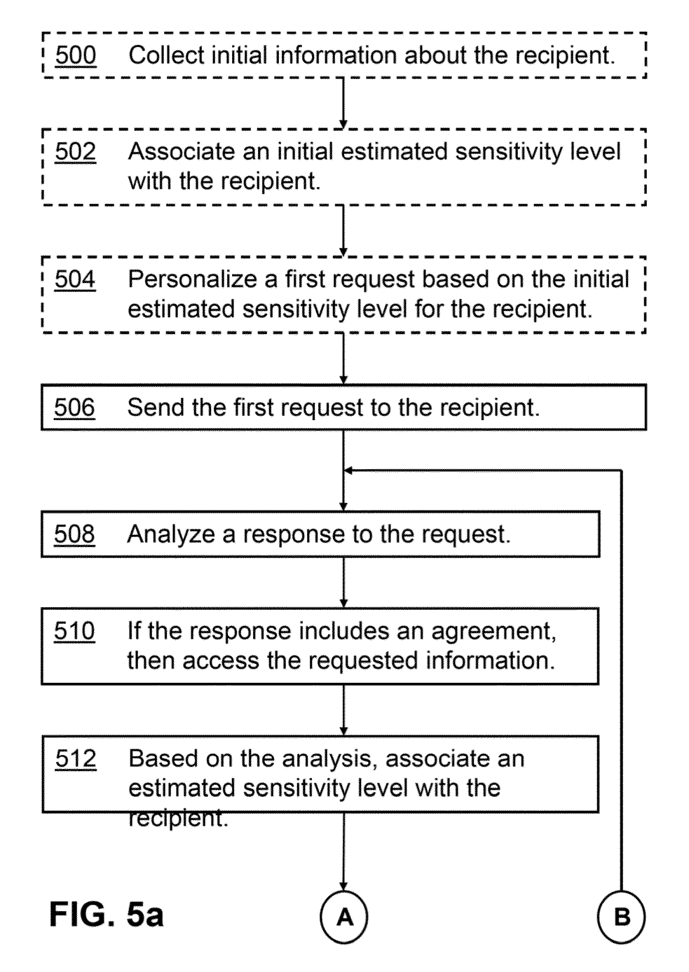

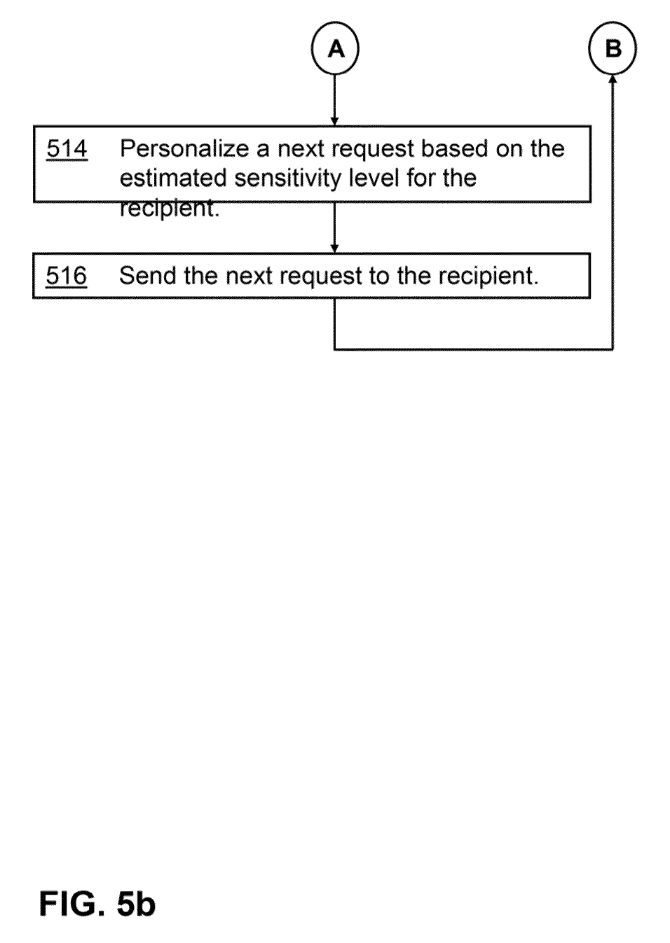

A third exemplary embodiment is illustrated in FIG. 5. As with the two previous examples, the method of FIG. 5 begins with optional steps for personalizing the first communication to the recipient 102.

The first communication is sent in step 506. Here, this communication is called a “request” because it explicitly asks the recipient 102 for access to data associated with him, but, unlike in the embodiment of FIG. 4, the request does not offer an explicit incentive in exchange for the access. It is expected that as the recipient 102 gains trust in an agent (possibly by means of the methods of FIGS. 3 and 4), he will grant access to his data even without the offer of the incentive.

While the communication in step 506 is a “request” rather than an “offer,” implicit incentives can be tied to the response of the recipient 102. For example, a higher level of service, frequent money-saving offers, and other perquisites could be given to recipients 102 who often respond to data-access requests, even though a particular response is not tied to a particular request.

The remainder of the method of FIG. 5 mirrors that of the previous two examples. The recipient's response is analyzed in step 508, the terms of the agreement are fulfilled, if appropriate, in step 510, and the privacy sensitivity of the recipient 102 is estimated, based on the response, in step 512. Further requests are personalized based on the recipient's estimated sensitivity (step 514 of FIG. 5b), sent to the recipient 102 (step 516), and analyzed (step 508 of FIG. 5a).

To be optimally effective, the message broker function 106 can use all of the methods illustrated above for a given recipient 102. Each interaction generates more data characterizing the recipient's preferences and behaviors. While only some of that collected data could be useful in personalizing further communications sent to the recipient 102, all of the data can be useful for other reasons. Also, the more recipients 102 that a given message broker 106 accesses, the wider its collection of data, and the more effective it can be. It is also recognized that the sensitivity level, carefully estimated through numerous rounds of communications and analyzed responses, may serve for purposes beyond that of personalizing the next communication.

In view of the many possible embodiments to which the principles of the present invention may be applied, it should be recognized that the embodiments described herein with respect to the drawing figures are meant to be illustrative only and should not be taken as limiting the scope of the invention. For example, other means of communications (e.g., other message types) are contemplated along with other incentives and other means of collected response data. Sophisticated data-analytics programs, as used with social-networking data, can be used to produce sophisticated estimates of privacy sensitivity of persons and of groups. Therefore, the invention as described herein contemplates all such embodiments as may come within the scope of the following claims and equivalents thereof.

1. A method for a message broker to gain access to information associated with a recipient in exchange for an incentive given to the recipient, the method comprising:
sending, by the message broker to the recipient, a first offer comprising a first incentive offered in exchange for allowing access to first information associated with the recipient;
analyzing, by the message broker, a response to the first offer;
if the response to the first offer comprises an acceptance of the first offer, then providing, by the message broker to the recipient, the first incentive and accessing, by the message broker, the first information;
based, at least in part, on the analyzing, associating, by the message broker, an estimated sensitivity level with the recipient;
personalizing, by the message broker, a second offer comprising a second incentive offered in exchange for allowing access to second information associated with the recipient, wherein the personalization is based, at least in part, on the estimated sensitivity level associated with the recipient; and
sending, by the message broker to the recipient, the second offer.

2. The method of claim 1 wherein the message broker is selected from the group consisting of: a server, a plurality of servers, a set-top box, a personal computer, a gaming console, and a personal communications device.

3. The method of claim 1 wherein the recipient is selected from the group consisting of: a person and a group of persons.

4. The method of claim 1 wherein the first offer is included in an element selected from the group consisting of: an advertising message, a game display, a menu, a purchase recommendation, a health-service recommendation, a routing recommendation, a television show, a web page, an e-mail message, a text message, and a telephone call.

5. The method of claim 1 wherein the first information includes an element selected from the group consisting of: health information, demographic information, preference information, social-group information, Internet-use information, behavioral information, software-use information, purchase information, content-consumption information, and contextual information.

6. The method of claim 1 wherein the first offer comprises a requested use of the first information, the requested use selected from the group consisting of: sharing the first information with a specified entity, storing the first information, and analyzing the first information.

7. The method of claim 1 wherein the first incentive includes an element selected from the group consisting of: a discount, a coupon, a cash equivalent, a service improvement, access to functionality, a game clue, a puzzle, a customized service, social presence information, membership in a group, shopping information, and removal of a disincentive.

8. The method of claim 1 wherein sending the first offer comprises associating the first offer with an agent.

9. The method of claim 1 wherein the response of the recipient comprises an element selected from the group consisting of: a null response, sending a message to the message broker, cancelling a service, placing a complaint, responding to a survey, posting information, and changing behavior associated with a product, service, or content.

10. The method of claim 1 wherein the estimated sensitivity level is based, at least in part, on an element selected from the group consisting of: a context of the recipient when the first offer is sent and a context of the recipient when the response to the first offer is made.

11. The method of claim 1 wherein the personalizing comprises adjusting an element selected from the group consisting of: a frequency of sending offers to the recipient, an estimated sensitivity of information requested from the recipient, an order of information requests in offers sent to the recipient, a value of the second incentive, a type of the second incentive, a requested use of the second information, an agent associated with the second offer, and a context of sending the second offer to the recipient.

12. The method of claim 1:
further comprising repeating, by the message broker, the analyzing, associating, personalizing, and sending using an updated estimated sensitivity level and a further offer;
wherein, for each offer, the estimated sensitivity level is increased if the recipient's response is negative with respect to the offer; and
wherein, for each offer, the estimated sensitivity level is decreased if the recipient's response is positive with respect to the offer.

13. The method of clam 12 wherein an amount of an increase or decrease in the estimated sensitivity level is based, at least in part, on an element selected from the group consisting of: a context of the recipient when the second communication is sent, a context of the recipient's activities made after the second communication is sent, activities of the recipient, demographics of the recipient, and attributes of the recipient.

14. The method of claim 1 further comprising, before sending the first offer:
collecting, by the message broker, initial information selected from the group consisting of: activities of the recipient, demographics of the recipient, and attributes of the recipient;
associating, by the message broker, an initial estimated sensitivity level with the recipient, wherein the initial estimated sensitivity level is based, at least in part, on the collected initial information; and
personalizing, by the message broker, the first offer, wherein the personalization is based, at least in part, on the initial estimated sensitivity level associated with the recipient.

15. A message broker for gaining access to information associated with a recipient in exchange for an incentive given to the recipient, the message broker comprising:
a transceiver configured for sending to the recipient a first offer comprising a first incentive offered in exchange for allowing access to first information associated with by the recipient; and
a processor operatively connected to the transceiver and configured for:
analyzing a response to the first offer;
if the response to the first offer comprises an acceptance of the first offer, then providing to the recipient the first incentive and accessing the first information;
based, at least in part, on the analyzing, associating an estimated sensitivity level with the recipient;
personalizing a second offer comprising a second incentive offered in exchange for allowing access to second information associated with the recipient, wherein the personalization is based, at least in part, on the estimated sensitivity level associated with the recipient; and
sending, via the transceiver to the recipient, the second offer.

16. The message broker of claim 15 wherein the message broker is selected from the group consisting of: a server, a plurality of servers, a set-top box, a personal computer, a gaming console, and a personal communications device.

17. The message broker of claim 15 wherein the recipient is selected from the group consisting of: a person and a group of persons.

18. The message broker of claim 15 wherein the first offer is included in an element selected from the group consisting of: an advertising message, a game display, a menu, a purchase recommendation, a health-service recommendation, a routing recommendation, a television show, a web page, an e-mail message, a text message, and a telephone call.

19. The message broker of claim 15 wherein the first information includes an element selected from the group consisting of: health information, demographic information, preference information, social-group information, Internet-use information, behavioral information, software-use information, purchase information, content-consumption information, and contextual information.

20. The message broker of claim 15 wherein the first offer comprises a requested use of the first information, the requested use selected from the group consisting of: sharing the first information with a specified entity, storing the first information, and analyzing the first information.

21. The message broker of claim 15 wherein the first incentive includes an element selected from the group consisting of: a discount, a coupon, a cash equivalent, a service improvement, access to functionality, a game clue, a puzzle, a customized service, social presence information, membership in a group, shopping information, and removal of a disincentive.

22. The message broker of claim 15 wherein sending the first offer comprises associating the first offer with an agent.

23. The message broker of claim 15 wherein the response of the recipient comprises an element selected from the group consisting of: a null response, sending a message to the message broker, cancelling a service, placing a complaint, responding to a survey, posting information, and changing behavior associated with a product, service, or content.

24. The message broker of claim 15 wherein the estimated sensitivity level is based, at least in part, on an element selected from the group consisting of: a context of the recipient when the first offer is sent and a context of the recipient when the response to the first offer is made.

25. The message broker of claim 15 wherein the personalizing comprises adjusting an element selected from the group consisting of: a frequency of sending offers to the recipient, an estimated sensitivity of information requested from the recipient, an order of information requests in offers sent to the recipient, a value of the second incentive, a type of the second incentive, a requested use of the second information, an agent associated with the second offer, and a context of sending the second offer to the recipient.

26. The message broker of claim 15:
wherein the processor is further configured for repeating the analyzing, associating, personalizing, and sending using an updated estimated sensitivity level and a further offer;
wherein, for each offer, the estimated sensitivity level is increased if the recipient's response is negative with respect to the offer; and
wherein, for each offer, the estimated sensitivity level is decreased if the recipient's response is positive with respect to the offer.

27. The message broker of claim 26 wherein an amount of an increase or decrease in the estimated sensitivity level is based, at least in part, on an element selected from the group consisting of: a context of the recipient when the second communication is sent, a context of the recipient's activities made after the second communication is sent, activities of the recipient, demographics of the recipient, and attributes of the recipient.

28. The message broker of claim 15 wherein the processor is further configured for, before sending the first offer:
collecting initial information selected from the group consisting of: activities of the recipient, demographics of the recipient, and attributes of the recipient;
associating an initial estimated sensitivity level with the recipient, wherein the initial estimated sensitivity level is based, at least in part, on the collected initial information; and
personalizing the first offer, wherein the personalization is based, at least in part, on the initial estimated sensitivity level associated with the recipient.
